(19) United States
(12) Patent Application Publication
(10) Pub. No.: US 2006/0082158 A1
(43) Pub. Date: Apr. 20, 2006

(54) Method and device for supplying power from acoustic energy

(76) Inventor: Jeffrey L. Schrader, Beaver, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 10/966,700

(22) Filed: Oct. 15, 2004

(51) Int. Cl. H02K 7/18; F03G 7/08; F02B 63/04

(52) U.S. Cl. 290/1 R

(57) ABSTRACT

The invention described is a method and device to convert existing ambient acoustic energy to an electric voltage.

### FIELD OF THE INVENTION

The present invention relates to a device and method for converting sound to electricity to be used as a power supply.

### BACKGROUND OF THE INVENTION

Electricity is generated when potential energy in a resource (e.g., water, wind, solar, sound, fossil fuels, etc.) is converted into electricity. Sound is a primary source of energy that can be converted into energy; however, the use of sound energy has not been exploited to date because sound produces lower power outputs as compared to other sources of resource energy. For example, a loud sound produces about 1 Watt per square meter, whereas sunlight produces over 1000 W/m2.

The advantage sound energy offers over many other resource-based sources is that sound, such as that from airports, busy freeways, large factory complexes, generators, waterfalls and the like, is typically constant; whereas sunlight and wind are intermittent. In addition, existing sound converted to energy does not increase pollution, such as that produced in the conversion of fossil fuels to energy.

Sound loudness is measured in decibels (db). Ambient noise, i.e., existing noise, is a frequent result of road transportation in heavily traveled and urban areas. The noise generated by cars, trucks, semis and buses creates ambient noise ranging from 70-85 db. Highway noise level grows arithmetically with speed. For instance, a car with a muffler traveling at 10 miles/hr emits about 45 db of noise, but emits about 70 db at 65 mph. Major airports have noise levels near 140-150 db during heavy periods.

A sound wave is a traveling pattern in which the air pressure increases and decreases rapidly with time. A sound wave can be a given frequency, or a series of frequencies, typically referred to as noise. Noise with a flat spectrum is called white noise. Ambient noise, such as that from a waterfall, can also be white noise.

Sound pressure is the force of sound on a surface area perpendicular to the direction of the sound. When a sound wave meets a surface, the wave exerts a force on the surface. Surfaces not rigidly fixed move in harmony with the pressure fluctuations in the wave creating an acoustic to mechanical energy transformation, which can be used to create a voltage. Existing systems, such as a microphone, work on this principle.

Sound spreading in open air and measured at a certain distance from the source is reduced by about 6 db for each doubling of that distance. Fixed surfaces, such as highway barriers absorb and or reflect sound. Absorption occurs by gathering the sound waves and dispersing the energy. Sound waves can also be collected by gathering the waves and forming a beam of waves by reflecting some of the diverging rays from the sides of a collector toward a given target.

Several methods exist to convert sound to electricity. An electromagnetic converter uses the motion between a magnet and a coil to convert vibrations to electrical motion. The magnet acts as the core of a coil and the motion creates magnetic flux variations inside the coil and thus an electromotive force. The oscillating mass is adjusted depending on the frequency of the vibrations to tune in the resonance frequency to increase voltage. A capacitive micro electro mechanical system generates energy with capacitors moving relative to each other in response to vibrations from sound. As the distance between the capacitors increases, the energy stored in them changes. Energy is tapped from the process in cycles. In this method, a separate voltage source is needed to initiate the process. A third type of converter is a piezoelectric converter, which generates a voltage due to charge separation in the material. Power is significantly higher from piezoelectric converters, but an independent power source is needed to initiate the process.

After an electrical voltage is created by a conversion of sound energy, the power may be used directly or stored. One method of storing energy is via a flywheel. A flywheel is a rotating disk used as a repository for angular momentum. Flywheels can be used to store up energy over a long period of time and then release it over a shorter period of time, temporarily magnifying power output for that period. A flywheel is more effective when its inertia is larger, as when its mass is located farther from the center of rotation either due to a more massive rim or due to a larger diameter.

No current method or device exists that supplies power generated from the conversion of ambient noise to an electric voltage using a device such as a flywheel for greater power output. Such a device would be useful for supplying power at a relatively low cost with low maintenance requirements. Such a device would also be useful as a power supply in remote locations.

### SUMMARY OF THE INVENTION

The invention described is a method and device to convert acoustic energy to an electric voltage and to increase the energy for use. The present invention comprises an acoustic to electric transducer connected to a flywheel. The transducer converts sound energy into an electrical charge. The sound energy is existing ambient energy. The converted energy is used to turn the shaft of a flywheel that accumulates power to supply a greater power output. The energy may be used to power one or more appliance. Multiply units of the invention may be linked and channeled into one or more appliance. As used herein, “appliance” refers to any item that requires a power source for operation, including permanent fixtures and temporary devices. “Appliance” further includes vehicles.

The system comprises an acoustic-to-electric transducer electronically connected to a converter. The transducer may be unidirectional or omni-directional and optionally includes a collector. The converter is electronically connected to a diode, which is electronically connected to, harmonized with, and provides energy to turn, a shaft of a flywheel. The flywheel comprises magnets that turn when the shaft turns to create an electric current in a stator, which optionally stores power. The stator is electronically connected to a rectifier, which is connectable to an appliance requiring power. Two or more systems may be linked and discharged in succession to supply a continuous current.

Power is discharged from the flywheel either automatically when the flywheel reaches its rated speed, timed, or in response to a power shortage in an existing system. The system may be combined with another power source, such as solar, water, wind, fossil fuel and or electric. In an embodiment, an appliance powered by a solar cell receives stored power discharged from the flywheel upon a drop in solar cell output.

The method of the system includes the steps of placing a transducer at an optimal distance from a loud noise source; transferring the energy produced in the transducer to a converter; converting the energy to a suitable voltage; transferring the converted energy to a diode harmonized to a flywheel; energizing the diode to turn a shaft of the flywheel; producing energy in the flywheel; discharging the energy through a rectifier after the flywheel has reached its rated speed, which may occur automatically, or may be stored and released at a given time or interval or in response to a power shortage in an existing system. After discharge, the cycle repeats itself. The method of providing power described and claimed herein is useful as a sole power source for an appliance or to provide a backup or supplemental power source for an appliance.

### BRIEF DESCRIPTION OF THE DRAWINGS

FIG. 1 is a schematic depiction of the components and the interaction of the system of the present invention.

### DETAILED DESCRIPTION OF THE INVENTION

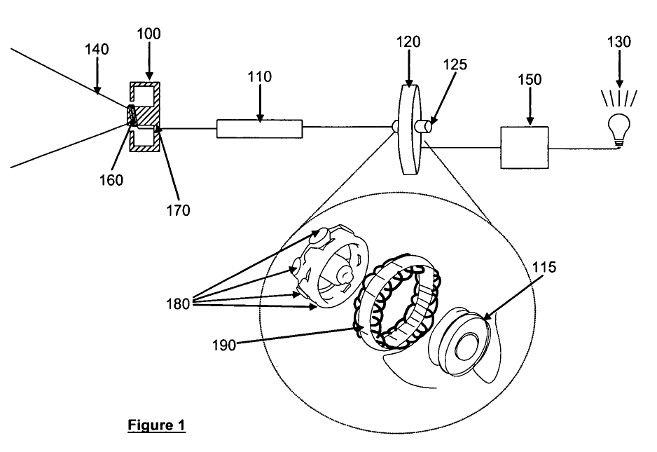

As depicted in FIG. 1, the present invention comprises an acoustic to electric transducer 100 connected to a flywheel 120. The transducer 100 produces an electrical current that is transferred to a converter 110, which converts energy to a suitable voltage. The converter 110 is connected to a diode 115 that energizes a shaft 125 of the flywheel 120. The flywheel 120 and the diode 115 are harmonized such that a small amount of electrical energy initiates the flywheel shaft 125. The flywheel 120 discharges power upon reaching a given speed or optionally stores the energy. The invention is optionally connected to one or more appliance that uses the discharged power 130.

The transducer 100 can be uni- or omni-directional. The transducer 100 is positioned at an optimal distance from a loud sound source. The source can be of any frequency or may be white noise. Sources include but are not limited to a freeway, an airport, a factory, a turbine, a generator or other loud machine, a waterfall, and the like.

The invention optionally uses means to collect sound 140, such as a cone, disk, dish, funnel, trumpet, and the like. The collector 140 gathers sound waves at a generally large end directed to the source of the sound and forms a beam of waves by reflecting some of the diverging rays from the sides of the collector 140 toward the transducer 100.

In an embodiment depicted in FIG. 1, the transducer 100 is a coil 160 and magnet 170 arrangement. When a sound wave reaches the transducer 100, the pressure of the wave moves the coil 160. The transducer 100 is optionally set to the given frequency of the sound or further comprises a filter to harvest a desired frequency from noise to provide optimum voltage output. The coil 160 moves through the magnetic field of the magnet 170, producing electricity in the coil 160. The electricity is transferred to a converter 110 linked to the transducer 100. The converter 110 is connected to a diode 115 that energizes the flywheel 120. The converter 110 converts the energy to a suitable voltage for use by the diode 115.

Magnets 180 that act as a rotor are imbedded within the flywheel 120. As the flywheel shaft 125 starts to turn in response to the energy from the diode 115, the magnets 180 move. As the magnets 180 rotate, an electric current is produced in a set of windings, or stator 190. The diode 115 gradually accelerates the flywheel 120. After the flywheel 120 reaches its rated speed and a fully charged state, it is ready to discharge. The discharge may be automatic, timed, or in response to a power shortage in an existing system.

During discharge, the output current from the stator 190 is passed through a rectifier 150 to create a suitable output for a given appliance. In discharge mode, the output remains constant. Upon discharge, the transducer 100 powers the converter 110 to recharge the flywheel 120 and the system repeats the creation and or storage of power. Two or more systems are optionally linked and discharged in succession to supply a continuous current.

The present invention may be combined with other power supplies and sources of energy, such as other resource-based power conversion systems. In an embodiment, the present invention is positioned at a loud waterfall. The noise energy is converted by the present invention while the water and wind energy are converted using hydro-electric and windmill converters. The alternate source energy is transferred to the same or a system specific flywheel that supplies power. In an alternate embodiment, the present invention is positioned at a windmill farm and harvest the noise produced by the windmills that are used to convert wind to an electrical voltage.

The system of the present invention is compatible with existing power systems and can be used as a back-up power source. In an embodiment, the power stored in the flywheel is released upon a drop in power from an existing power source.

The invention is optionally operated intermittently with a traditional or resource-based power source. In an embodiment, the power in the flywheel is released upon a solar cell drop in output that occurs on a cloudy day or when the sun goes down. In an embodiment where the appliance is a vehicle, the rectifier is connected to a differential that creates movement in the vehicle, such as the wheels of a car.

The present invention's power storage and regeneration system provides a reliable no-maintenance power supply for any appliance. The present invention is useful as a power source for a remote appliance, including but not limited to a road sign or warning light. The present invention provides a clean, quiet, no-maintenance, environment-friendly power supply.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

What is claimed is:

1. A system to provide power comprising an acoustic-to-electric transducer electronically connected to a converter, said transducer optionally including a collector, said converter electronically connected to a diode, said diode electronically connected to, harmonized with, and providing energy to turn, a shaft of a flywheel, said flywheel comprising magnets that turn when the shaft turns to create an electric current in a stator that stores dischargeable power, said stator electronically connected to a rectifier, said rectifier connectable to an appliance requiring power.

2. The system of claim 1 wherein power is discharged from the flywheel upon the occurrence of one of automatically when the flywheel reaches its rated speed, timed, or in response to a power shortage in an existing system.

3. The system of claim 1 wherein the transducer is unidirectional or omni-directional.

4. The system of claim 1 wherein the stored power is discharged upon a trigger.

5. The system of claim 4 wherein the trigger is a drop in power from an existing power source.

6. A power source comprising two or more system of claim 1 linked and discharged in succession to supply a continuous current.

7. The system of claim 1 combined with another power source.

8. The system of claim 7 wherein the other power source is one of solar, water, wind, fossil fuel and electric.

9. The system of claim 7 wherein an appliance powered by a solar cell receives stored power discharged from the flywheel upon a drop in solar cell output.

10. The system of claim 7 wherein the power is transferred to a differential of a vehicle.

11. The system of claim 1 wherein the power supplies a remote appliance.

12. The system of claim 11 where the remote appliance is a road sign warning light.

13. The system of claim 1 wherein the transducer is set to the given frequency of a sound source.

14. A method of providing power comprising:
1) placing a transducer at an optimal distance from a loud noise source;
2) transferring energy produced in the transducer to a converter;
3) converting the energy to a suitable voltage in the converter;
4) transferring the converted energy to a diode harmonized to a flywheel;
5) energizing the diode with the converted energy to turn a shaft of the flywheel;
6) producing energy in the flywheel;
7) discharging the energy through a rectifier after the flywheel has reached its rated speed, said discharge occurring automatically, timed, or in response to a power shortage in an existing system; and
8) repeating steps 2 through 7.

15. The method of claim 14 wherein the transducer is unidirectional or omni-directional.

16. The method of claim 14 comprising the step of discharging the energy to an appliance.

17. A method of supplying power comprising combining two or more of the system claimed in claim and linking and discharging the systems in succession to supply a continuous current to an appliance.

18. The method of claim 14 comprising the step of combining the energy discharged with another power source.

19. The method of claim 18 comprising the steps of storing the energy and discharging the stored energy to an appliance powered by a solar cell upon a drop in solar cell output.

20. The method of claim 18 comprising the step of transferring the energy to a differential of a vehicle.
